(19) United States
(12) Patent Application Publication
(10) Pub. No.: US 2026/0170791 A1
(43) Pub. Date: Jun. 18, 2026

(54) METHOD AND SYSTEM FOR REAL-TIME THREE-DIMENSIONAL SCENE GRAPH CREATION

(71) Applicant: GM Global Technology Operations LLC, Detroit, MI (US)

(72) Inventors: Guangyu Zou, Warren, MI (US); Han Ul Lee, Sterling Heights, MI (US)

(73) Assignee: GM Global Technology Operations LLC, Detroit, MI (US)

(21) Appl. No.: 18/979,317

(22) Filed: Dec. 12, 2024

(51) Int. Cl. G06V 10/426; G06V 10/77; G06V 10/82; G06V 20/56

(52) U.S. Cl. CPC G06V 10/426; G06V 10/7715; G06V 10/82; G06V 20/56

(57) ABSTRACT

A system and method include receiving, as input to a transformer model, sensor data corresponding to a two-dimensional (2D) image of a current scene of a vehicle, and encoding, using a birds-eye view encoder, the sensor data to generate a corresponding sequence of feature embeddings. Here, the sequence of feature embeddings corresponds to a three-dimensional (3D) representation of the current scene of the vehicle. The system and method also include decoding the sequence of feature embeddings using two or more feature-specific decoders executing in parallel, and processing, using a prediction network, the decoded sequence of feature embeddings to convert the decoded sequence feature embeddings into semantic features. The system and method further include processing, using a topology network, the semantic features and the decoded sequence of feature embeddings to generate an adjacency matrix representing a 3D view of the current scene of the vehicle.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to real-time three-dimensional scene graph creation. In the realm of autonomous vehicle technology, scene graphs are pivotal for enabling vehicles to perceive and interact with their surroundings. Currently, scene graphs are generated using a combination of sensor data from cameras, light detection and ranging (LiDAR), radar, and ultrasonic sensors. These sensors provide a representation of the environment of the vehicle, which is then processed to identify objects, their positions, and their movements. This information is used by the vehicle's autonomous systems to make decisions about navigation and maneuvering. However, the existing methods primarily focus on two-dimensional data.

Despite advancements in sensor technology, current scene graph construction methods lack the integration of three-dimensional information predictions. Three-dimensional predictions of scene graphs may enable the vehicle to plan more precise trajectories, especially in complex driving scenarios. For instance, three-dimensional scene graphs are essential for capturing the spatial relationships and depth information necessary for accurate vehicle trajectory and maneuver planning. With this crucial data, autonomous vehicles may truly understand a scene to navigate safely and efficiently, particularly in environments with varying elevations, obstacles, and dynamic elements.

### SUMMARY

One aspect of the disclosure provides a computer-implemented method that when executed on data processing hardware causes the data processing hardware to perform operations that include receiving, as input to a transformer model, sensor data corresponding to a two-dimensional (2D) image of a current scene of a vehicle, and encoding, using a birds-eye view encoder, the sensor data to generate a corresponding sequence of feature embeddings. Here, the sequence of feature embeddings corresponds to a three-dimensional (3D) representation of the current scene of the vehicle. The operations also include decoding the sequence of feature embeddings using two or more feature-specific decoders executing in parallel, and processing, using a prediction network, the decoded sequence of feature embeddings to convert the decoded sequence feature of embeddings into semantic features. The operations further include processing, using a topology network, the semantic features and the decoded sequence of feature embeddings to generate an adjacency matrix representing a 3D view of the current scene of the vehicle.

Implementations of the disclosure may include one or more of the following optional features. In some implementations, the two or more feature-specific decoders executing in parallel each include a plurality of transformer layers. In these implementations, each transformer layer may include a cross-attention head. Additionally or alternatively, decoding the sequence of feature embeddings using the two or more feature-specific decoders executing in parallel may include executing cross-attention of the sequence of feature embeddings between corresponding transformer layers of the two or more feature-specific decoders.

In some examples, the sensor data includes a set of image frames. In these examples, the operations may further include, for each image frame of the set of image frames, extracting feature embeddings of the current scene. Here, encoding, using the birds-eye view encoder, the sensor data to generate the corresponding sequence of feature embeddings may include projecting the sensor data into the corresponding sequence of feature embeddings. In some implementations, the prediction network includes a multilayer perceptron network. In some examples, the 2D image of the current scene of the vehicle includes at least two elements. In these examples, the adjacency matrix may predict a strength of the relationship between the at least two elements.

Another aspect of the disclosure provides a system including data processing hardware and memory hardware in communication with the data processing hardware. The memory hardware stores instructions that when executed by the data processing hardware cause the data processing hardware to perform operations that include receiving, as input to a transformer model, sensor data corresponding to a two-dimensional (2D) image of a current scene of a vehicle, and encoding, using a birds-eye view encoder, the sensor data to generate a corresponding sequence of feature embeddings. Here, the sequence of feature embeddings corresponds to a three-dimensional (3D) representation of the current scene of the vehicle. The operations also include decoding the sequence of feature embeddings using two or more feature-specific decoders executing in parallel, and processing, using a prediction network, the decoded sequence of feature embeddings to convert the decoded sequence feature of embeddings into semantic features. The operations further include processing, using a topology network, the semantic features and the decoded sequence of feature embeddings to generate an adjacency matrix representing a 3D view of the current scene of the vehicle.

This aspect may include one or more of the following optional features. In some implementations, the two or more feature-specific decoders executing in parallel each include a plurality of transformer layers. In these implementations, each transformer layer may include a cross-attention head. Additionally or alternatively, decoding the sequence of feature embeddings using the two or more feature-specific decoders executing in parallel may include executing cross-attention of the sequence of feature embeddings between corresponding transformer layers of the two or more feature-specific decoders.

In some examples, the sensor data includes a set of image frames. In these examples, the operations may further include, for each image frame of the set of image frames, extracting feature embeddings of the current scene. Here, encoding, using the birds-eye view encoder, the sensor data to generate the corresponding sequence of feature embeddings may include projecting the sensor data into the corresponding sequence of feature embeddings. In some examples, the 2D image of the current scene of the vehicle includes at least two elements. In these examples, the adjacency matrix may predict a strength of the relationship between the at least two elements.

Another aspect of the disclosure provides a computer-implemented method that when executed on data processing hardware causes the data processing hardware to perform operations that include receiving, as input to a transformer model, sensor data corresponding to a two-dimensional (2D) image of a current scene of a vehicle, the 2D image including at least two elements. The operations also include encoding, using a birds-eye view encoder, the sensor data to generate a corresponding sequence of feature embeddings. Here, the sequence of feature embeddings corresponds to a three-dimensional (3D) representation of the current scene of the vehicle. The operations further include decoding the sequence of feature embeddings using two or more feature-specific decoders executing in parallel, and processing, using a topology network, the decoded sequence of feature embeddings to generate an adjacency matrix representing a 3D view of the current scene of the vehicle. Here, the adjacency matrix predicts a strength of the relationship between the at least two elements.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic view of an example system for real-time three-dimensional scene graph creation.

FIG. 2 is a schematic view of example components of the system of FIG. 1.

FIGS. 3A and 3B are example views of a two-dimensional scene and corresponding three-dimensional scene, respectively.

FIG. 4 is a schematic view of example feature decoders of a transformer model of the system of FIG. 1.

FIG. 5 is a flowchart of an example arrangement of operations for a method of real-time three-dimensional scene graph creation.

FIG. 6 is a flowchart of an example arrangement of operations for a method of real-time three-dimensional scene graph creation.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

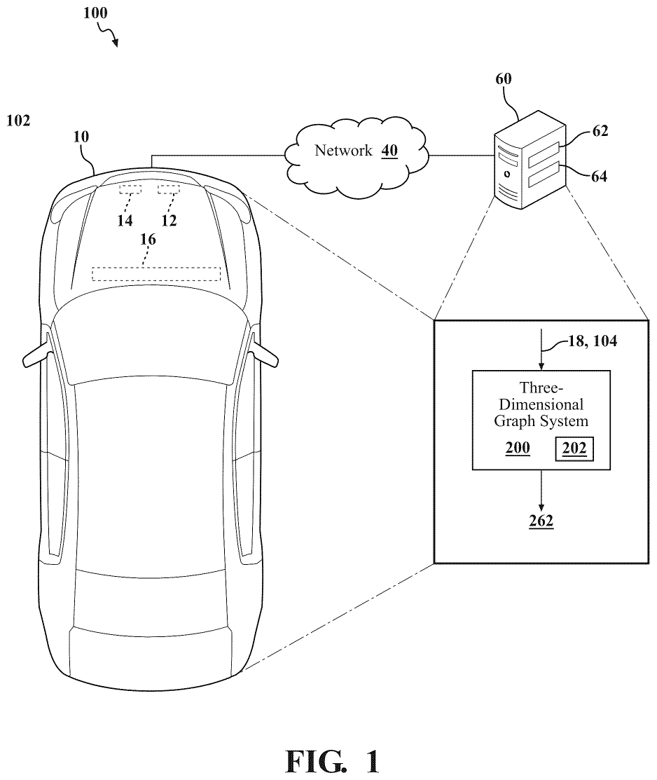

Referring to FIG. 1, in some implementations, a system 100 includes a vehicle 10 in communication with a remote system 60 via a network 40. The network 40 may include a wireless local area network (WLAN) that facilitates communication and interoperability between the vehicle 10 and the remote system 60 within an environment of the vehicle 10. Thus, the network 40 can include Wireless Fidelity (WiFi®) (e.g., IEEE 802.11), Low-Rate Wireless Personal Area Networks (e.g., IEEE 802.15.4), worldwide interoperability for microwave access (WiMAX), 3G, 4G, Long Term Evolution (LTE), 5G, digital subscriber line (DSL), Bluetooth, Near Field Communication (NFC), or any other wireless standards, or Ethernet (e.g., IEEE 802.3). The system 100 may additionally include one or more access points (AP) (not shown) configured to facilitate wireless communication between the vehicle 10 and the remote system 60.

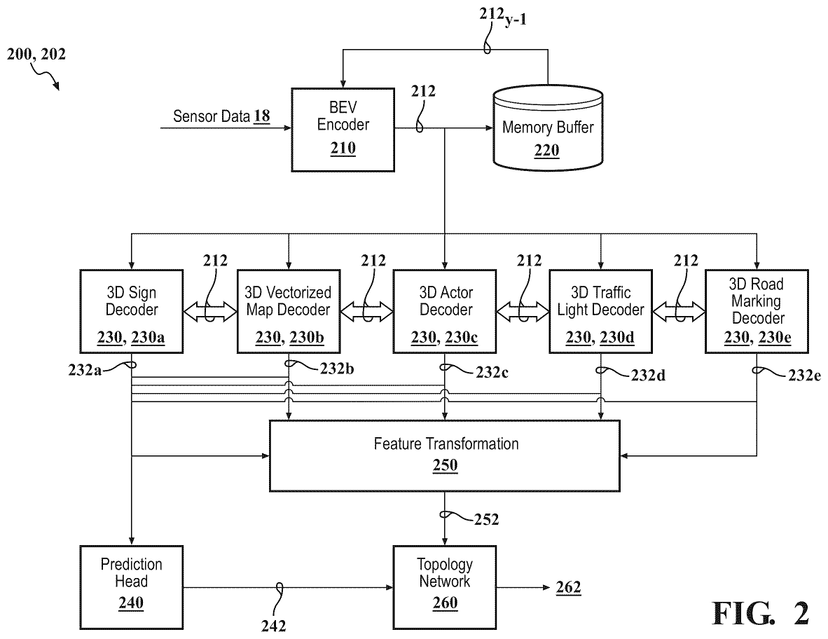

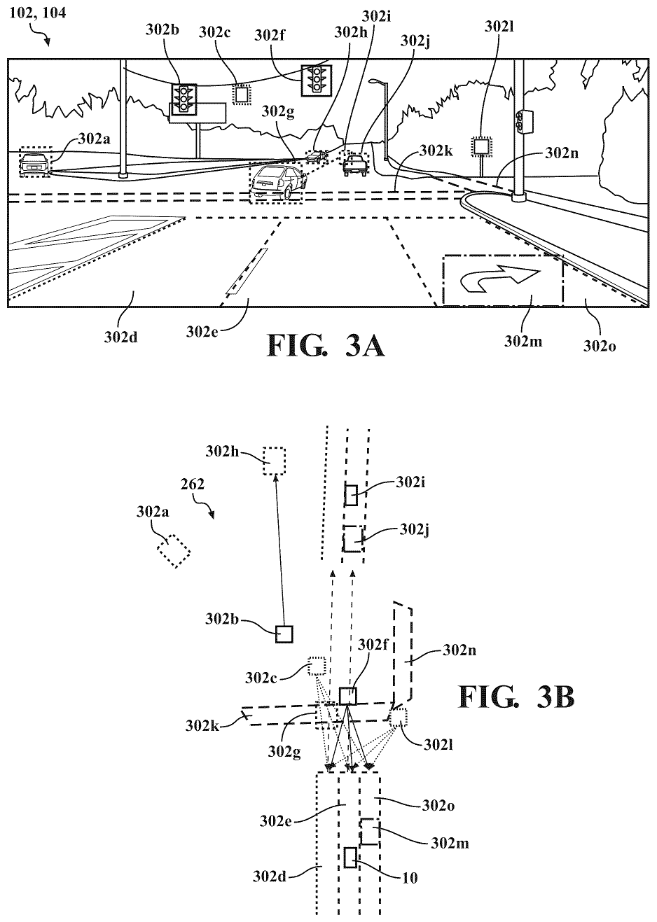

As shown, the vehicle 10 and/or the remote system 60 execute a three-dimensional (3D) graph system 200 (FIG. 2) configured to receive sensor data 18 of a scene 102 of the vehicle 10, infer one or more elements 302 (FIG. 3A) in the scene 102 and their relationships simultaneously, and generate/predict a fully 3D scene graph of the scene 102 surrounding the vehicle 10 for downstream applications of the vehicle 10. As described in further detail below, two or more decoders 230 of the 3D graph system 200 that execute in parallel may pull/share feature embeddings 212 via a cross-attention mechanism. By executing tasks in parallel, this sharing of feature embeddings 212 provides synergy between the two or more decoders 230 that not only improves performance of the 3D graph system 200 over existing perception systems but allows for the real-time generation of an adjacency matrix 262 representing the 3D scene graph of the scene 102 surrounding the vehicle 10. Advantageously, the construction of the adjacency matrix 262 allows downstream applications to more clearly understand the scene 102 for safer and more accurate maneuvers, particularly in autonomous driving modes.

In the example shown, the 3D graph system 200 is implemented within the vehicle 10. However, the 3D graph system 200 can be implemented in any other propulsion system, such as, without limitation, motorcycles, trucks, off-road vehicles, farm equipment, trains, aircraft, and the like. Additionally, while the 3D graph system 200 is shown implemented within a vehicle 10, it can be implemented on other computing devices (e.g., computing devices in communication with the vehicle 10), such as, without limitation, a smart phone, tablet, smart display, desktop/laptop, smart watch, smart appliance, or smart glasses/headset. The vehicle 10 includes data processing hardware 12 and memory hardware 14 storing instructions that when executed on the data processing hardware 12 cause the data processing hardware 12 to perform operations.

As shown in FIGS. 1 and 2, the vehicle 10 is configured to receive sensor data 18 detected/captured by a sensor system 16. The sensor system 16 may include one or more of cameras, a forward collision mitigation system, radio detection and ranging (RADAR), light detection and ranging (LIDAR) capable of capturing image data, and other external sensors of the vehicle 10. While the sensor system 16 shown in FIG. 1 is disposed on a front side of the vehicle, it should be appreciated that the sensor system 16 may include sensors located throughout the vehicle 10. For example, the sensor system 16 may provide 360-degree surround sensing of an environment of the vehicle 10.

The sensor data 18 may include one or more image frames 104 of the scene 102 located outside of the vehicle 10. Notably, the one or more image frames 104 of the scene 102 are two-dimensional (2D). These image frames 104 may capture one or more elements 302 within the image frame 104. As used herein, elements 302 may generally refer to dynamic elements such as pedestrians and cars, as well as static elements such as traffic lights, road signs, road markings, etc. While the image frames 104 are 2D, the downstream applications of the vehicle 10 benefit from 3D representations of the scene 102, such as the position and orientation of each element 302, as well as the relationship between elements 302 in order to fully plan for vehicle maneuvers.

The remote system 60 (e.g., server, cloud computing environment) also includes data processing hardware 62 and memory hardware 64 storing instructions that when executed on the data processing hardware 62 cause the data processing hardware 62 to perform operations. In some examples, execution of the 3D graph system 200 is shared across the vehicle 10 and the remote system 60. As described in greater detail with respect to FIGS. 1-4, the 3D graph system 200 executing on the vehicle 10 and/or the remote system 60 executes a transformer model 202 that is configured to receive sensor data 18 including the image frames 104 capturing the one or more elements 302 represented in 2D and generate an adjacency matrix 262 representing a 3D view of the elements 302 in the current scene 102 of the vehicle 10.

Referring to FIG. 2, the 3D scene graph system 200 executing the transformer model 202 is shown. The transformer model 202 is a deep neural network (DNN) that includes a birds-eye view (BEV) encoder 210, a plurality of feature specific decoders 230, 230a-e configured to execute/process in parallel, a prediction head 240 (also referred to as a prediction network 240), a feature transformation module 250, and a topology network 260. Additionally, the transformer model 202 of the 3D scene graph system 200 has access to a memory buffer 220. The memory buffer may include previously generated feature embeddings 212y-1 corresponding to previous scenes 102 encountered by the vehicle 10, and may be stored in the memory hardware 14, 64 of FIG. 1.

As shown, the 3D scene graph system 200 continuously receives/processes the sensor data 18 including the one or more elements 302 detected by the sensor system 16 to identify one or more elements 302 in the sensor data 18. The BEV encoder 210 receives, as input, the 2D sensor data 18 and encodes the sensor data 18 to generate, as output, a sequence of feature embeddings 212 representing the elements 302 in the sensor data 18. As described above, the sensor data 18 may include a set of image frames 104. Here, for each image frame 104 of the sensor data 18, the BEV encoder 210 may extract feature embeddings for the current scene 102 of the vehicle 10. In these instances, the BEV encoder 210 may encode the sensor data 18 to generate the corresponding sequence of feature embeddings 212 by projecting the sensor data 18 into the corresponding sequence of feature embeddings 212. In some instances, the BEV encoder 210 generates the sequence of feature embeddings 212 based on the previous time-step of the sequence of feature embeddings 212_{y-1}.

Thereafter, the 3D graph system 200 may store the sequence of feature embeddings 212 in the memory buffer 220. Additionally, each of the feature-specific decoders 230a-230e receives, as input, the sequence of feature embeddings 212, and generates, as output a decoded sequence of feature embeddings 232. As shown, the feature-specific decoders 230a-230e include a 3D sign decoder 230 a, a 3D vectorized map decoder 230 b, a 3D actor decoder 230 c (i.e., dynamic elements 302), a 3D traffic light decoder 230 d, and a 3D road marking decoder 230e. Each feature-specific decoder 230 may be specifically trained to extract specific features from sensor data 18 that correlate to a specific category such as, without limitation, signs, maps (e.g., topography of a road), dynamic elements 302, traffic lights, road markings, etc. It should be understood that, although five (5) feature-specific decoders 230 are shown, the disclosure contemplates that more decoders 230, or fewer decoders 230 may also be used to implement the 3D graph system 200.

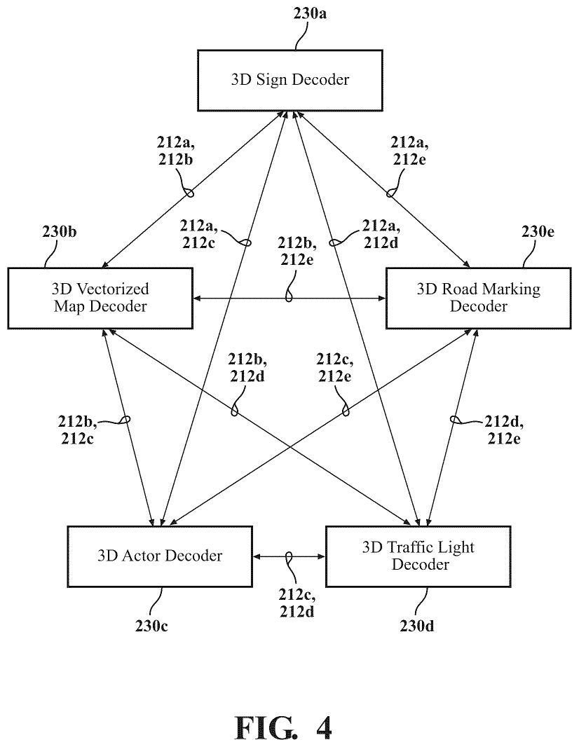

Referring briefly to FIG. 4. Each of the feature-specific decoders 230a-230e is shown, where each feature-specific decoder 230 is communicatively coupled with each of the other feature-specific decoders 230. One or more of the feature-specific decoders 230a-230e may include a multilayer perceptron (MLP) network. In some instances, each feature-specific decoder 230 may include a plurality of transformer layers. Here, each transformer layer of each respective feature-specific decoder 230 may include at least one cross-attention head configured to perform inter-feature information passing of the respective feature embeddings 212a-212e between the other feature-specific decoders 230a-230e. For example, at each time-step of processing by each of the feature-specific decoders 230a-230e, each feature-specific decoder 230 may determine the positional estimates of the sequence of feature embeddings 212, and when the sequence of feature embeddings 212a of a first feature specific decoder 230a are within a threshold distance of the sequence of feature embeddings 212b of a second-feature specific decoder 230b, the feature-specific decoders 230a, 230b may execute cross-attention of the sequence of feature embeddings 212a, 212b between the transformer layers of the first feature-specific decoder 230a and the second feature-specific decoder 230b. Thereafter, the feature-specific decoders 230a, 230b may perform channel-wise concatenation to concatenate the sequence of feature embeddings 212a, 212b and pass the concatenated sequence of feature embeddings 212a, 212b to a feed-forward network for the next time-step of processing. As should be apparent from FIG. 4, at each time-step, the feature-specific decoders 230a-230e may execute this cross-attention mechanism between one another in parallel.

Referring again to FIG. 2, the prediction head 240 receives, as input, the decoded sequence of feature embeddings 232a-232e output from the feature-specific decoders 232a-232e and processes the decoded sequence of feature embeddings 232 to convert the decoded sequence of feature embeddings 232 into semantic features 242. For instance, the semantic features 242 may include one or more of the category, width, height, position (e.g., xyz coordinates), and orientation of each of the one or more elements 302 in the scene 102. In some cases, the prediction head 240 includes an MLP network. For example, both a regressor and classifier of the prediction head 240 may be each implemented as an MLP network, where the regressor MLP network is configured to generate a regression prediction indicating the semantic features 242 of the position and orientation of each element 302, while the classifier MLP network is configured to generate a classification prediction of the type (e.g., dynamic elements such as pedestrians and cars, as well as static elements such as traffic lights, road signs, road markings) of element 302 is present in the scene 102. Similarly, the feature transformation module 250 receives, as input, the decoded sequence of feature embeddings 232a-232e output from the feature-specific decoders 232a-232e and processes the decoded sequence of feature embeddings 232 to convert the decoded sequence of feature embeddings 232 into transformed features 252. Like the prediction head 240, the feature transformation module 250 may be implemented as an MLP network.

Thereafter, the topology network 260 may receive, as input, one or more of the decoded sequence of feature embeddings 232, the semantic features 242, and the transformed features 252, and generate, as output, the adjacency matrix 262 representing a 3D view of the current scene 102. Here, the topology network 250 is trained to process the input feature embeddings 232, the semantic features 242, and the transformed features 252 to determine which elements 302 present in the scene 102 are strongly connected semantically. For instance, the topology network 260 may predict a confidence for the relationship between each element 302 and the other elements 302 in the scene 102 and, based on the predicted confidences of each pair of elements 302, generate the adjacency matrix 262 representing the 3D view of the current scene 102 of the vehicle 10. In other words, the adjacency matrix 262 predicts the strength of the relationship between at least two elements 302 in the scene 102 of the vehicle 10. Here, the topology network 260 may infer topological information about the 3D view of the current scene based on the predicted confidences of the associations between each pair of elements 302 in the scene 102.

Referring to FIGS. 3A and 3B, example views of a 2D scene 102 and its corresponding adjacency matrix 262 of the 3D view of the scene 1012, are shown respectively. With particular reference to FIG. 3A, an image frame 104 of the current scene 102 of the vehicle 10 is shown in 2D. In the image frame 104, a plurality of elements 302a-302o are shown. In particular, the 3D graph system 200 may identify that the scene 102 includes the dynamic elements 302a, 302g, 302h, 302i, and 302j corresponding to cars, static elements 302b, 302f corresponding to traffic lights, static elements 302c, 3021 corresponding to road signs, static elements 302d, 302e, 302o corresponding to lanes, and static elements 302k, 302m, 302 n corresponding to road markings. After the 3D graph system 200 processes the image frame 104 of the current scene 102, it generates, as output, the adjacency matrix 262 shown in FIG. 3B. Here, the adjacency matrix 262 includes each of the same elements 302a-302o, but represents each of the elements 302 a-302o as a birds-eye-view 3D perspective around the vehicle 10. In addition to the strength of the relationship between pairs of elements 302, the adjacency matrix 262 may also include the relative size, location, and orientation of each of the elements 302a-302o with respect to the vehicle 10 and to the other elements 302a-302o. Notably, the adjacency matrix 262 may transmitted to downstream applications of the vehicle 10 (e.g., steering control, brake control, etc.) for planning maneuvers of the vehicle 10 as it drives along the road.

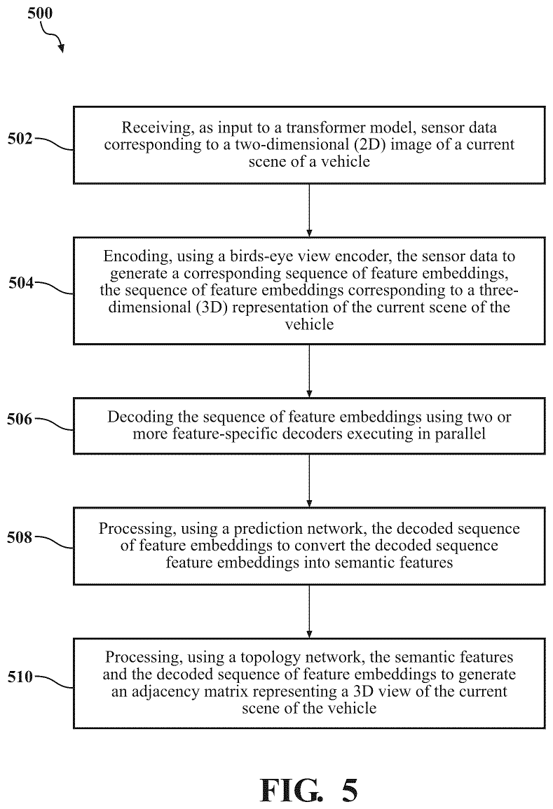

FIG. 5 includes a flowchart of an example arrangement of operations for a method 500 for real-time three-dimensional (3D) scene graph creation. The method 500 may be described with reference to FIGS. 1-4. Data processing hardware (e.g., data processing hardware 12, 62 of FIG. 1) may execute instructions stored on memory hardware (e.g., memory hardware 14, 64 of FIG. 1) to perform the example arrangement of operations for the method 500.

At operation 502, the method 500 includes receiving, as input to a transformer model 202, sensor data 18 corresponding to a two-dimensional (2D) image of a current scene 102 of a vehicle 10. At operation 504, the method 500 includes encoding, using a birds-eye view encoder 210, the sensor data 18 to generate a corresponding sequence of feature embeddings 212. Here, the corresponding sequence of feature embeddings 212 correspond to a three-dimensional (3D) representation of the current scene 102 of the vehicle 10.

At operation 506, the method 500 also includes decoding the sequence of feature embeddings 212 using two or more feature specific decoders 230, 230a-e executing in parallel. The method 500 also includes, at operation 508, processing, using a prediction network 240, the decoded sequence of feature embeddings 232 to convert the decoded sequence of feature embeddings 232 into semantic features 242. At operation 510, the method 500 further includes processing, using a topology network 260, the semantic features 242 and the decoded sequence of feature embeddings 232 to generate an adjacency matrix 262 representing a 3D view of the current scene 102 of the vehicle 10.

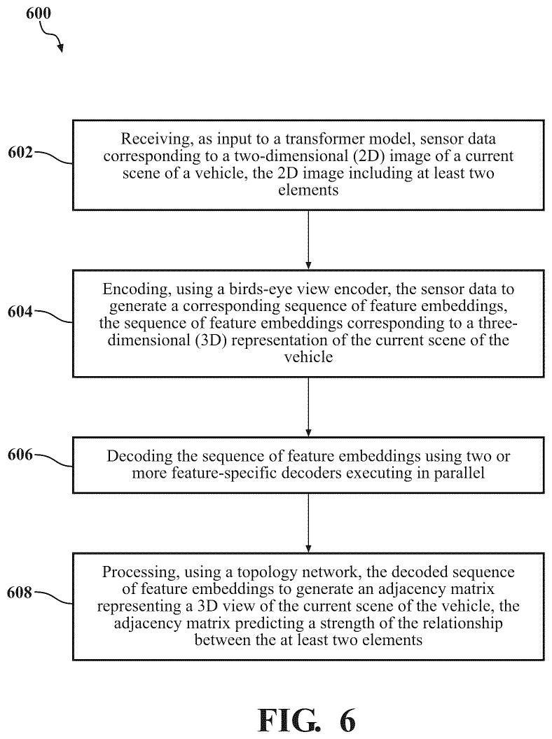

FIG. 6 includes a flowchart of an example arrangement of operations for a method 600 for real-time three-dimensional (3D) scene graph creation. The method 600 may be described with reference to FIGS. 1-4. Data processing hardware (e.g., data processing hardware 12, 62 of FIG. 1) may execute instructions stored on memory hardware (e.g., memory hardware 14, 64 of FIG. 1) to perform the example arrangement of operations for the method 600.

The method 600 includes, at operation 602, receiving, as input to a transformer model 202, sensor data 18 corresponding to a two-dimensional (2D) image of a current scene 102 of a vehicle 10. Here, the 2D image includes at least two elements 302. At operation 604, the method 600 includes encoding, using a birds-eye view encoder 210, the sensor data 18 to generate a corresponding sequence of feature embeddings 212. Here, the corresponding sequence of feature embeddings 212 correspond to a three-dimensional (3D) representation of the current scene 102 of the vehicle 10.

At operation 606, the method 600 further includes decoding the sequence of feature embeddings 212 using two or more feature specific decoders 230, 230a-e executing in parallel. At operation 608, the method 600 includes processing, using a topology network 260, the decoded sequence of feature embeddings 232 to generate an adjacency matrix 262 representing a 3D view of the current scene 102 of the vehicle 10. Here, the adjacency matrix 262 predicts a strength of the relationship between the at least two elements 302.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method executed on data processing hardware that causes the data processing hardware to perform operations comprising:
receiving, as input to a transformer model, sensor data corresponding to a two-dimensional (2D) image of a current scene of a vehicle;
encoding, using a birds-eye view encoder, the sensor data to generate a corresponding sequence of feature embeddings, the sequence of feature embeddings corresponding to a three-dimensional (3D) representation of the current scene of the vehicle;
decoding the sequence of feature embeddings using two or more feature-specific decoders executing in parallel;
processing, using a prediction network, the decoded sequence of feature embeddings to convert the decoded sequence feature of embeddings into semantic features; and
processing, using a topology network, the semantic features and the decoded sequence of feature embeddings to generate an adjacency matrix representing a 3D view of the current scene of the vehicle.

2. The method of claim 1, wherein the two or more feature-specific decoders executing in parallel each include a plurality of transformer layers.

3. The method of claim 2, wherein each transformer layer includes a cross-attention head.

4. The method of claim 2, wherein decoding the sequence of feature embeddings using the two or more feature-specific decoders executing in parallel comprises executing cross-attention of the sequence of feature embeddings between corresponding transformer layers of the two or more feature-specific decoders.

5. The method of claim 1, wherein the sensor data includes a set of image frames.

6. The method of claim 5, wherein operations further comprise, for each image frame of the set of image frames, extracting feature embeddings of the current scene.

7. The method of claim 6, wherein encoding, using the birds-eye view encoder, the sensor data to generate the corresponding sequence of feature embeddings comprises projecting the sensor data into the corresponding sequence of feature embeddings.

8. The method of claim 1, wherein the prediction network comprises a multilayer perceptron network.

9. The method of claim 1, wherein the 2D image of the current scene of the vehicle comprises at least two elements.

10. The method of claim 9, wherein the adjacency matrix predicts a strength of the relationship between the at least two elements.

11. A system comprising:
data processing hardware; and
memory hardware in communication with the data processing hardware, the memory hardware storing instructions that when executed on the data processing hardware cause the data processing hardware to perform operations comprising:
receiving, as input to a transformer model, sensor data corresponding to a two-dimensional (2D) image of a current scene of a vehicle;
encoding, using a birds-eye view encoder, the sensor data to generate a corresponding sequence of feature embeddings, the sequence of feature embeddings corresponding to a three-dimensional (3D) representation of the current scene of the vehicle;
decoding the sequence of feature embeddings using two or more feature-specific decoders executing in parallel;
processing, using a prediction network, the decoded sequence of feature embeddings to convert the decoded sequence of feature embeddings into semantic features; and
processing, using a topology network, the semantic features and the decoded sequence of feature embeddings to generate an adjacency matrix representing a 3D view of the current scene of the vehicle.

12. The system of claim 11, wherein the two or more feature-specific decoders executing in parallel each include a plurality of transformer layers.

13. The system of claim 12, wherein each transformer layer includes a cross-attention head.

14. The system of claim 12, wherein decoding the sequence of feature embeddings using the two or more feature-specific decoders executing in parallel comprises executing cross-attention of the sequence of feature embeddings between corresponding transformer layers of the two or more feature-specific decoders.

15. The system of claim 11, wherein the sensor data includes a set of image frames.

16. The system of claim 15, wherein operations further comprise, for each image frame of the set of image frames, extracting feature embeddings of the current scene.

17. The system of claim 16, wherein encoding, using the birds-eye view encoder, the sensor data to generate the corresponding sequence of feature embeddings comprises projecting the sensor data into the corresponding sequence of feature embeddings.

18. The system of claim 11, wherein the 2D image of the current scene of the vehicle comprises at least two elements.

19. The system of claim 18, wherein the adjacency matrix predicts a strength of the relationship between the at least two elements.

20. A computer-implemented method executed on data processing hardware that causes the data processing hardware to perform operations comprising:
receiving, as input to a transformer model, sensor data corresponding to a two-dimensional (2D) image of a current scene of a vehicle, the 2D image including at least two elements;
encoding, using a birds-eye view encoder, the sensor data to generate a corresponding sequence of feature embeddings, the sequence of feature embeddings corresponding to a three-dimensional (3D) representation of the current scene of the vehicle;
decoding the sequence of feature embeddings using two or more feature-specific decoders executing in parallel;
processing, using a topology network, the decoded sequence of feature embeddings to generate an adjacency matrix representing a 3D view of the current scene of the vehicle, the adjacency matrix predicting a strength of the relationship between the at least two elements.
